(19) United States
(12) Patent Application Publication
(10) Pub. No.: US 2026/0171053 A1
(43) Pub. Date: Jun. 18, 2026

(54) LYRICS GENERATION APPARATUS, LYRICS GENERATION METHOD, AND NON-TRANSITORY COMPUTER-READABLE MEDIUM

(71) Applicant: NEC Corporation, Tokyo (JP)

(72) Inventors: Shota KIZUKURI, Tokyo (JP); Takahisa Yutoku, Tokyo (JP); Yoshihiko Koizumi, Tokyo (JP); Takuro Nunokawa, Tokyo (JP)

(73) Assignee: NEC Corporation, Tokyo (JP)

(21) Appl. No.: 19/407,231

(22) Filed: Dec. 3, 2025

(30) Foreign Application Priority Data
Dec. 17, 2024 (JP) 2024-221138

(51) Int. Cl. G10H 1/00; G06F 40/279; G06F 40/30; G06F 40/40

(52) U.S. Cl. CPC G10H 1/0025; G06F 40/279; G06F 40/30; G06F 40/40; G10H 2210/111

(57) ABSTRACT

A lyrics generation apparatus according to the present disclosure performs: acquiring news data indicating content of news; generating, by using the news data, a first prompt that instructs to generate lyrics of a song based on a summary of the news, a keyword of the news, or both of them; and generating lyrics data indicating the lyrics, by inputting the first prompt to a first generation model.

### INCORPORATION BY REFERENCE

This application is based upon and claims the benefit of priority from Japanese patent application No. 2024-221138, filed on Dec. 17, 2024, the disclosure of which is incorporated herein in its entirety by reference.

### TECHNICAL FIELD

The present disclosure relates to a lyrics generation apparatus, a lyrics generation method, and a non-transitory computer-readable medium.

### BACKGROUND ART

Techniques for providing news have been developed. For example, JP 2022-092032 A discloses a technique for outputting vocal voice of singing news and singing voice with accompaniment by performing singing synthesis using a text of the news as lyrics.

### SUMMARY

In the invention of JP 2022-092032 A, it is possible to generate only singing voice for singing content of news as it is. The present disclosure has been made in view of the problem, and an example object of the present disclosure is to provide a new technology for providing news.

A lyrics generation apparatus according to an example aspect of the present disclosure includes at least one memory that is configured to store instructions and at least one processor that is configured to execute the instructions to: acquire news data indicating content of news; generate a first prompt that instructs to generate lyrics of a song based on a summary of the news, a keyword of the news, or both of these, using the news data; and generate lyrics data indicating the lyrics, by inputting the first prompt to a first generation model.

A lyrics generation method according to an example aspect of the present disclosure is executed by a computer. The lyrics generation method includes: acquiring news data indicating content of news; generating a first prompt that instructs to generate lyrics of a song based on a summary of the news, a keyword of the news, or both of these, using the news data; and generating lyrics data indicating the lyrics, by inputting the first prompt to a first generation model.

A non-transitory computer-readable medium according to an example aspect of the present disclosure stores a program that causes a computer to execute: acquiring news data indicating content of news; generating a first prompt that instructs to generate lyrics of a song based on a summary of the news, a keyword of the news, or both of these, using the news data; and generating lyrics data indicating the lyrics, by inputting the first prompt to a first generation model.

According to the present disclosure, a new technology for providing news is provided.

### BRIEF DESCRIPTION OF DRAWINGS

FIG. 1 is a diagram illustrating an overview of an operation of a lyrics generation apparatus;

FIG. 2 is a block diagram illustrating a functional configuration of the lyrics generation apparatus;

FIG. 3 is a block diagram illustrating a hardware configuration of a computer that achieves the lyrics generation apparatus;

FIG. 4 is a flowchart illustrating a flow of processing executed by the lyrics generation apparatus;

FIG. 5 is a diagram illustrating a template of a first prompt;

FIG. 6 is a diagram illustrating schedule information;

FIG. 7 is a diagram illustrating an overview of the operation of the lyrics generation apparatus;

FIG. 8 is a block diagram illustrating the functional configuration of the lyrics generation apparatus; and

FIG. 9 is a flowchart illustrating the flow of the processing executed by the lyrics generation apparatus.

### EXAMPLE EMBODIMENT

Hereinafter, example embodiments of the present disclosure will be described in detail with reference to the drawings. In the drawings, the same or related elements are denoted by the same reference numerals, and repeated description is omitted as necessary for clarity of description. Unless otherwise described, preset values such as predetermined values or threshold values are stored in advance in a storage device or the like accessible from a device using the values. Furthermore, unless otherwise described, a storage unit includes one or more storage devices of any number.

### First Example Embodiment

### Overview

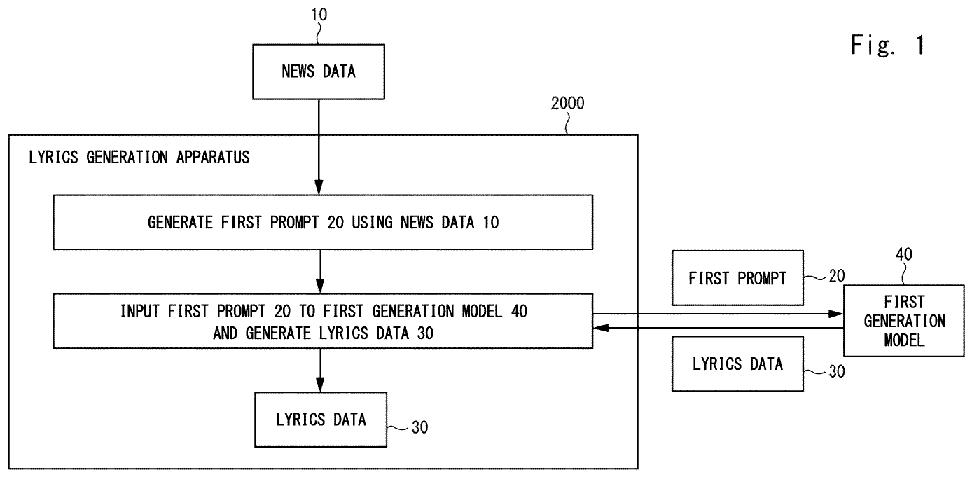

FIG. 1 is a diagram illustrating an overview of an operation of a lyrics generation apparatus 2000. Here, FIG. 1 is a diagram for facilitating understanding of the overview of the lyrics generation apparatus 2000, and the operation of the lyrics generation apparatus 2000 is not limited to that illustrated in FIG. 1.

The lyrics generation apparatus 2000 generates lyrics data 30 indicating lyrics based on content of news, using news data 10. The news data 10 is text data indicating the content of the news. The lyrics data 30 includes text data of the lyrics based on the content of the news.

The lyrics generation apparatus 2000 generates the lyrics data 30 using a first generation model 40. The first generation model 40 is configured to output a text indicating the lyrics, in response to an input of a prompt for instructing to generate the lyrics. The first generation model 40 may be a generation model specialized in generation of the lyrics or may be a general-purpose generation model that can generate various types of data in response to a request.

The lyrics generation apparatus 2000 generates a first prompt 20 using the news data 10. The first prompt 20 is a prompt for instructing generation of lyrics using a summary of news, a keyword of the news, or both of these, for the news indicated by the news data 10. Then, the lyrics generation apparatus 2000 generates the lyrics data 30, by inputting the first prompt 20 to the first generation model 40.

### Example of Operation and Effect

According to the lyrics generation apparatus 2000 according to the present example embodiment, the lyrics data 30 is generated, based on the summary of the news, the keyword of the news, or both of these, for the news indicated by the news data 10. By generating the lyrics data 30 based on the summary of the news, the keyword of the news, or both of these, it is possible to generate the lyrics data 30, focusing on an important part of the news. Therefore, for example, the lyrics data 30 can be generated, without depending too much on specific content of the news indicated by the news data 10.

Hereinafter, the lyrics generation apparatus 2000 according to the present example embodiment will be described in more detail.

### Example of Functional Configuration

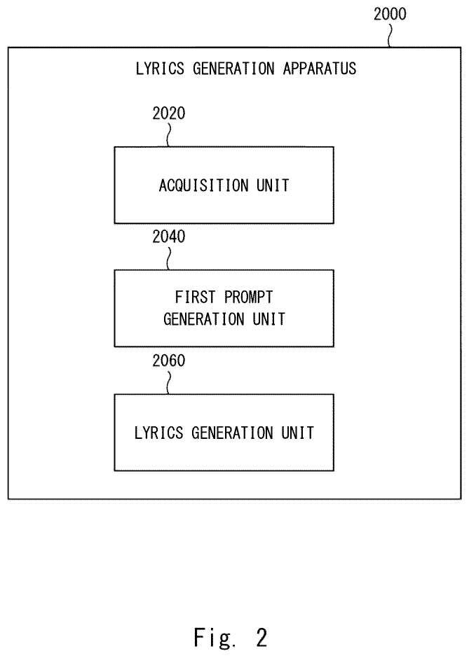

FIG. 2 is a block diagram illustrating a functional configuration of the lyrics generation apparatus 2000. The lyrics generation apparatus 2000 includes an acquisition unit 2020, a first prompt generation unit 2040, and a lyrics generation unit 2060. The acquisition unit 2020 acquires the news data 10. The first prompt generation unit 2040 generates the first prompt 20 using the news data 10. The lyrics generation unit 2060 generates the lyrics data 30, by inputting the first prompt 20 to the first generation model 40.

### Example of Hardware Configuration

Each functional configuration unit of the lyrics generation apparatus 2000 is achieved, for example, by hardware that achieves each functional configuration unit. Here, the hardware that achieves each functional configuration unit is, for example, a hard-wired electronic circuit or the like. In addition, for example, each functional configuration unit of the lyrics generation apparatus 2000 is achieved by a combination of hardware and software. Here, a specific example of the combination of the hardware and the software is a combination of an electronic circuit and a program for controlling the electronic circuit, or the like.

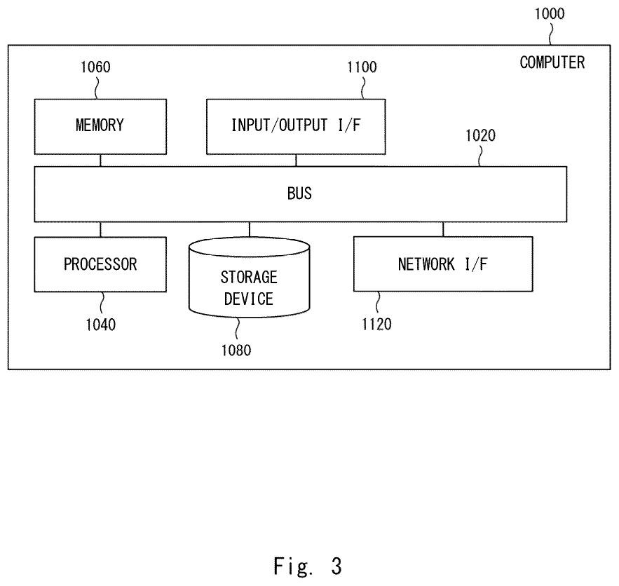

FIG. 3 is a block diagram illustrating a hardware configuration of a computer 1000 that achieves the lyrics generation apparatus 2000. The computer 1000 is any computer. For example, the computer 1000 is a stationary computer such as a personal computer (PC) or a server machine. In another example, the computer 1000 is a portable computer such as a smartphone or a tablet terminal. In yet another example, the computer 1000 is an integrated circuit such as a System on Chip (SoC). The computer 1000 may be a dedicated computer designed to achieve the lyrics generation apparatus 2000, or may be a general-purpose computer.

For example, each function of the lyrics generation apparatus 2000 is achieved in the computer 1000 by installing a predetermined application with respect to the computer 1000. The above-described application is configured by a program for achieving each functional configuration unit of the lyrics generation apparatus 2000.

The method of acquiring the program is optional. For example, the program can be acquired, from a storage medium that stores the program. The storage medium that stores the program is any storage medium such as a Digital Versatile Disk (DVD) or a Universal Serial Bus (USB) memory. In addition, for example, the program can be acquired by downloading the program from a server apparatus that manages a storage device in which the program is stored.

The computer 1000 includes a bus 1020, a processor 1040, a memory 1060, a storage device 1080, an input/output interface 1100, and a network interface 1120. The bus 1020 is a data transmission path for the processor 1040, the memory 1060, the storage device 1080, the input/output interface 1100, and the network interface 1120 to transmit and receive data to and from each other. However, a method of connecting the processor 1040 and the like to each other is not limited to the bus connection.

The processor 1040 is various arithmetic devices such as a Central Processing Unit (CPU), a Microprocessor Unit (MPU), a Graphics Processing Unit (GPU), a Field-Programmable Gate Array (FPGA), or a Digital Signal Processor (DSP). The memory 1060 is a main storage device achieved by using a Random Access Memory (RAM) or the like. The storage device 1080 is an auxiliary storage device achieved using a hard disk, a Solid State Drive (SSD), a memory card, a Read Only Memory (ROM), or the like.

The input/output interface 1100 is an interface connecting the computer 1000 with an input/output device. For example, an input device such as a keyboard and an output device such as a display device are connected to the input/output interface 1100.

The network interface 1120 is an interface connecting the computer 1000 to a network. The network may be a Local Area Network (LAN) or a Wide Area Network (WAN).

The storage device 1080 stores the program (program for achieving above-described application) for achieving each functional configuration unit of the lyrics generation apparatus 2000. The processor 1040 achieves each functional configuration unit of the lyrics generation apparatus 2000 by reading and executing this program in the memory 1060.

The lyrics generation apparatus 2000 may be achieved using the plurality of computers 1000. In this case, the plurality of computers 1000 is connected to each other by a network, a bus, or the like. Configurations of the plurality of computers 1000 may be the same as or different from each other.

### Flow of Processing

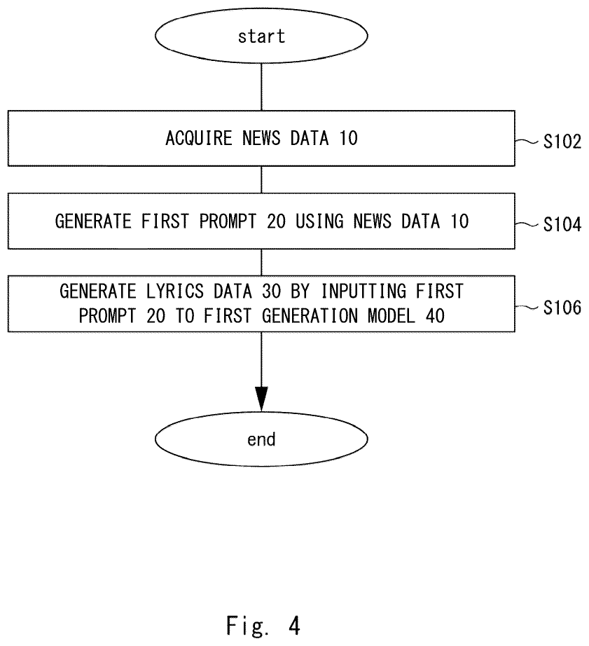

FIG. 4 is a flowchart illustrating a flow of processing executed by the lyrics generation apparatus 2000. The acquisition unit 2020 acquires the news data 10 (S102). The first prompt generation unit 2040 generates the first prompt 20 using the news data 10 (S104). The lyrics generation unit 2060 generates the lyrics data 30, by inputting the first prompt 20 to the first generation model 40 (S106).

### Acquisition of News Data 10: S102

The acquisition unit 2020 acquires the news data 10 (S102). There are various methods of acquiring the news data 10. For example, the news data 10 is transmitted from another apparatus to the lyrics generation apparatus 2000. In this case, the acquisition unit 2020 acquires the news data 10, by receiving the news data 10 transmitted from the another apparatus.

The apparatus that transmits the news data 10 to the lyrics generation apparatus 2000 is, for example, a terminal (hereinafter, user terminal) used by a user of the lyrics generation apparatus 2000. The user terminal is any computer such as a smartphone or a PC.

For example, the lyrics generation apparatus 2000 provides an input screen for inputting news, to the user terminal. The input screen is provided, for example, as a webpage. The user inputs a text indicating news to the input screen displayed on the user terminal. The user terminal transmits the text input to the input screen to the lyrics generation apparatus 2000. The acquisition unit 2020 acquires the text transmitted from the user terminal, as the news data 10.

The acquisition unit 2020 may receive an input of information for specifying news and acquire the news. The information for specifying the news is, for example, a Uniform Resource Locator (URL) of a webpage on which the news is posted, or the like.

For example, the acquisition unit 2020 provides an input screen on which the information for specifying the news can be input, to the user terminal. The acquisition unit 2020 acquires a text of the news specified by the information input to the input screen, as the news data 10.

The acquisition unit 2020 may automatically acquire the news data 10. For example, the acquisition unit 2020 acquires the news data 10, by exploring information regarding the news. For example, the exploration of the information regarding the news is achieved by accessing a predetermined webpage where the information regarding the news is provided and obtaining the information regarding the news. In addition, for example, the exploration of the information regarding the news is achieved by crawling the Internet and collecting the information regarding the news. In addition, for example, the exploration of the information regarding the news is achieved by accessing a database that records the information regarding the news and obtaining the information regarding the news.

There are various methods of acquiring the news data 10 by exploring the information regarding the news. For example, the acquisition unit 2020 acquires the news data 10, by exploring the information regarding the news at a predetermined time every day. As a more specific example, the acquisition unit 2020 obtains information regarding news ranked first in a news ranking at the time when the exploration is performed, as the news data 10. In addition, for example, the acquisition unit 2020 acquires each piece of information regarding news ranked at a predetermined rank or higher in the ranking, as the news data 10. In a case where the plurality of pieces of news data 10 is obtained in this way, the lyrics generation apparatus 2000 generates the lyrics data 30 for each of the plurality of pieces of news data 10.

A frequency at which the exploration of the information regarding the news is performed is optional, and is not limited to once a day.

The news indicated by the news data 10 may be limited to news in a predetermined genre. For example, it is assumed that the predetermined genre be “computer security”. In this case, the news data 10 is obtained, for news regarding the computer security. For example, in a case where the news data 10 is acquired by exploring the information regarding the news, the acquisition unit 2020 explores only news in the predetermined genre. As described above, in a case where the ranking information is used, the news data 10 is acquired, using a ranking about the news in the predetermined genre.

The genre of the news data 10 may be determined in advance or may be specified by the user. In addition, for example, in a case where the user uses a news application, a user's preferred genre may be specified, based on a use history of the news application. In this case, the acquisition unit 2020 obtains the news data 10, for news in the user's preferred genre.

### Generation of First Prompt 20: S104

The first prompt generation unit 2040 generates the first prompt 20 using the news data 10 (S104). The first prompt 20 is a prompt for instructing the generation of the lyrics using the summary of the news, the keyword of the news, or both of these, for the news indicated by the news data 10.

For example, the first prompt 20 includes a first instruction text representing a phrase for instructing to generate lyrics and a second instruction text representing various types of information to be used to generate the lyrics. The first instruction text is, for example, a text representing the instruction for generating the lyrics, such as “Please write lyrics using the following information”.

The second instruction text includes at least a text of the summary or the keyword of the news indicated by the news data 10. In a case where the second instruction text includes the summary of the news data 10, the first prompt generation unit 2040 generates the summary of the news data 10, using the news data 10. Then, the first prompt generation unit 2040 includes the generated summary of the news data 10 in the first prompt 20.

Here, various types of processing can be adopted for processing for generating the summary of the text. In a case where the first generation model 40 is a generation model that can generate a summary of sentences, the first prompt generation unit 2040 may generate the summary of the news data 10, by inputting the news data 10 to the first generation model 40.

In a case where the second instruction text includes the keyword of the news, the first prompt generation unit 2040 extracts one or more keywords from the news data 10. Then, the first prompt generation unit 2040 includes each extracted keyword in the first prompt 20.

Here, various types of processing can be adopted for processing for extracting the keyword from the text. In a case where the first generation model 40 is a generation model that can extract a keyword from a text, the first prompt generation unit 2040 may extract the keyword from the news data 10, by inputting the news data 10 to the first generation model 40.

The second instruction text may further include information other than the summary and the keyword of the news data 10. For example, the second instruction text includes designation of an intention to create lyrics. By giving the intention to create the lyrics to the first generation model 40, the first generation model 40 can write the lyrics in consideration of the creation intention. The intention to create the lyrics is, for example, “briefly convey content of news”, “convey a trend obtained from news”, “convey a lesson obtained from news”, or the like.

In addition, for example, the second instruction text may include designation of a word and a phrase that should not be included in the lyrics. Hereinafter, the word and the phrase are collectively expressed as a word or the like. The word or the like that should not be included in the lyrics is also expressed as an inappropriate word. By including the inappropriate word in the second instruction text, it is possible to prevent an inappropriate word or phrase from being included in the lyrics data 30.

The inappropriate word may be specified by a specific word or the like or may be specified by a type of a word or the like. In the latter case, for example, the inappropriate word is a proper noun, a company name, a business institution name, a personal name, or the like. In addition, for example, the inappropriate word may be specified by a function of a word or the like, such as “a word or phrase that can specify an individual”.

In addition, for example, the second instruction text includes designation of various parameters related to a song. Hereinafter, the parameter related to the song is also referred to as a song parameter.

The song parameter is, for example, a section configuration of a song. The song includes one or more sections such as intro, verse, chorus, or outro. Therefore, for example, by listing the sections in the second instruction text, the section configuration of the song can be designated.
Intro
Verse 1
Verse 2
Chorus
Outro

In addition, for example, the song parameter is a genre of the song. The genre is, for example, J-pop, K-pop, rock, Hawaiian, vocaloid, or the like.

In addition, for example, the song parameter is a tempo of the song. The tempo of the song may be quantitatively or qualitatively expressed. The quantitative expression of the tempo of the song is, for example, a value of Beats per Minutes (BPM), a range of the BPM, or the like. The qualitative expression of the tempo of the song is, for example, an expression such as “quite fast”, “fast”, “normal”, “slow”, or “quite slow”.

In addition, for example, the song parameter is a mood of the song. The mood of the song represents an atmosphere of the song. The mood of the song is represented, for example, by a type of the mood such as upbeat, emotional, or energetic.

In addition, for example, the song parameter is a scene of the song. The scene of the song represents a scene suitable for the song. The scene of the song is represented, for example, by a type of a scene such as a club or seaside.

The second instruction text may include any constraint, other than various constraints described above. For example, the second instruction text may include a constraint “Please take the summary of the news as context” or the like. By including the constraint, it is possible to more abstractly understand the news and create the lyrics, without depending too much on information specific to the news.

The first prompt 20 is generated, for example, using a template. For example, the template is stored in advance in a storage unit accessible from the lyrics generation apparatus 2000. Here, the plurality of types of templates may be prepared. In this case, the first prompt generation unit 2040 may receive designation of the template from the user.

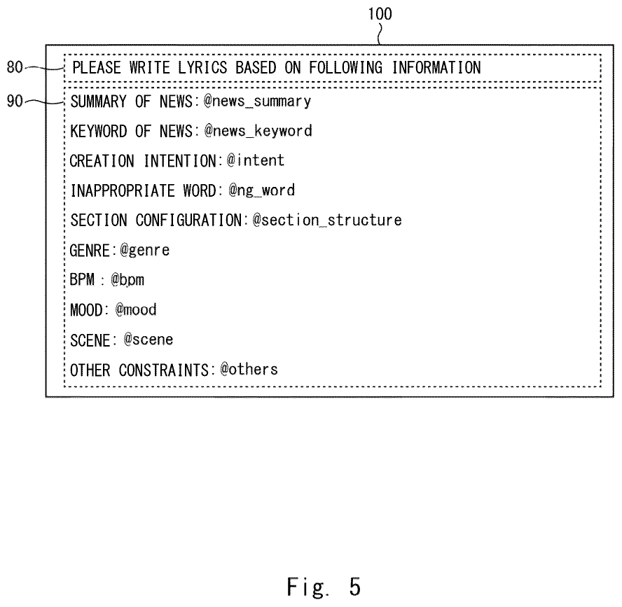

FIG. 5 is a diagram illustrating a template of the first prompt 20. A template 100 illustrated in FIG. 5 includes a first instruction text 80 and a second instruction text 90. In FIG. 5, a fixed text is set to the first instruction text 80. The second instruction text 90 includes a text representing a name of an item and a mark for embedding content of the item, for each of the plurality of items.

For example, for an item called the summary of the news, the second instruction text 90 includes a text representing a name of an item “summary of news:” and a mark “@news_summary”. In a case where the summary of the news is included in the first prompt 20, the first prompt generation unit 2040 generates a text representing the summary of the news using the news data 10 and replaces “@news_summary” with the generated text.

Here, the items of the second instruction text 90 used to generate the first prompt 20 may be all items indicated in the template 100 or may be some of the items indicated in the template 100. In the latter case, for example, the first prompt generation unit 2040 replaces a mark of only an item to be used with a text, in the second instruction text 90 of the template 100. Moreover, the first prompt generation unit 2040 deletes a name of an item and a mark (that is, row of item), for the item of which the mark is not replaced with a specific text.

The designation of the item of the second instruction text 90 included in the first prompt 20 and the content of the item are designated by the user, for example. For example, the first prompt generation unit 2040 presents an input screen for requesting the user to input, for each item indicated in the second instruction text 90 of the template 100. However, since the text indicating the summary of the news and the keyword of the news is generated using the news data 10, it is not necessary to request the user to input.

The content of each item of the second instruction text 90 may be determined in advance in association with a condition related to a schedule such as a date or a day of the week. Hereinafter, information for associating the condition related to the schedule with the content of each item of the second instruction text 90 is referred to as schedule information.

For example, the schedule information indicates a combination of values of the song parameter, for each day of the week. In this case, for example, the first prompt generation unit 2040 acquires a combination of the values of the song parameter related to a current day of the week, from the schedule information, and includes the combination in the first prompt 20.

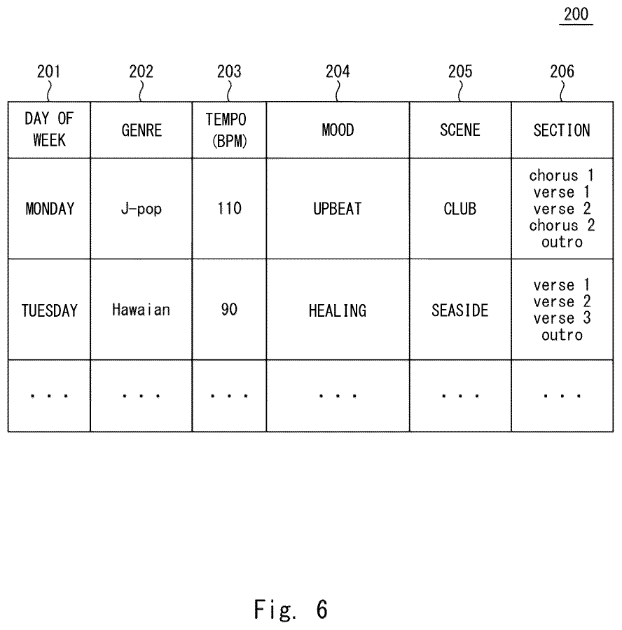

FIG. 6 is a diagram illustrating the schedule information. In FIG. 6, schedule information 200 includes columns of a day of a week 201, a genre 202, a tempo 203, a mood 204, a scene 205, and a section 206. With the configuration, the schedule information 200 indicates a combination of the genre, the tempo, the mood, the scene, and the section configuration, for each day of the week. For example, in a case where the current day of the week is Monday, the first prompt generation unit 2040 acquires a genre, a BPM, a mood, a scene, and a section configuration related to Monday from the schedule information 200 and uses the genre, the BPM, the mood, the scene, and the section configuration to generate the first prompt 20.

A method of automatically specifying the value of the song parameter is not limited to the method using the schedule information 200. For example, the value of the song parameter may be determined in association with a type of an entity related to the news. The type of the entity related to the news is, for example, a type of an organization that has caused a matter. In this case, the first prompt generation unit 2040 specifies the entity related to the news, using the news data 10 and includes a value of the song parameter determined in association with the specified entity, in the first prompt 20.

In addition, for example, the song parameter may be determined in association with a keyword extracted from the news. In this case, the first prompt generation unit 2040 includes a value of the song parameter determined in association with the keyword extracted from the news data 10, in the first prompt 20.

### Generation of Lyrics Data 30: S106

The lyrics generation unit 2060 generates the lyrics data 30, by inputting the first prompt 20 to the first generation model 40 (S106). As described above, the first generation model 40 outputs a text representing lyrics, in response to an input of a prompt for instructing to generate the lyrics. Therefore, the lyrics data 30 is obtained by inputting the first prompt 20 to the first generation model 40.

For example, the first generation model 40 is a language model configured to output a text of an answer to a request, in response to an input of a text of the request. For example, the first generation model 40 is a general-purpose language model, trained in advance to output an answer to an optional request. In this case, for example, the first generation model 40 is trained, using a plurality of pieces of training data (hereinafter, first training data) in which an optional request text and a ground truth answer text for the request text are associated. As the language model that outputs the answer to the optional request, for example, any language model classified into a Large Language Model (LLM) can be used. However, the first generation model 40 does not need to be classified into the LLM.

In addition, for example, the first generation model 40 may be a language model exclusively prepared for the lyrics generation apparatus 2000. In this case, the first generation model 40 is trained, using a plurality of pieces of training data (hereinafter, second training data) in which the first prompt 20 and ground truth lyrics related to the first prompt 20 are associated.

In addition, the first generation model 40 may be a language model that is further trained using the second training data, for a general-purpose language model generated by training using the first training data.

### Regarding Lyrics Data 30

As described above, the lyrics data 30 includes the text data of the lyrics based on the content of the news. The lyrics data 30 may further include another piece of information regarding the lyrics, in addition to the text indicating the lyrics.

For example, the lyrics data 30 is expressed by associating the section and the lyrics. More specifically, the lyrics data 30 may indicate association “name of section: lyrics included in the section”, for each section.

It is assumed that the section configuration be “chorus 1, verse 1, verse 2, chorus 2, and outro”. In this case, the lyrics data 30 indicates “chorus 1: lyrics of chorus 1”, “verse 1: lyrics of verse 1”, “verse 2: lyrics of verse 2”, and “chorus 2: lyrics of chorus 2”.

The lyrics generation unit 2060 may cause the first generation model 40 to generate a title of the song. For example, by making the instruction in the first instruction text described above be an instruction “Please create lyrics and title”, it is possible to cause the first generation model 40 to generate the title of the song. In a case where the title of the song is generated in this way, the lyrics data 30 further indicates the title.

### Output by Lyrics Generation Apparatus 2000

The lyrics generation apparatus 2000 may output a processing result by any method. For example, the lyrics generation apparatus 2000 outputs the lyrics data 30.

There are various output modes of the lyrics data 30. For example, the lyrics generation apparatus 2000 stores the lyrics data 30 in any storage unit. In addition, for example, the lyrics generation apparatus 2000 displays content of the lyrics data 30 on any display device, by outputting the lyrics data 30 to the display device. In addition, for example, the lyrics generation apparatus 2000 transmits the lyrics data 30 to another apparatus (for example, user terminal described above).

From the lyrics generation apparatus 2000, information other than the lyrics data 30 may be further output. For example, the lyrics generation apparatus 2000 outputs the first prompt 20 used to generate the lyrics data 30. An output mode of the first prompt 20 is similar to the output mode of the lyrics data 30.

The lyrics data 30 is output, for example, at a timing when the user browses the news. In this case, the lyrics generation apparatus 2000 acquires the news data 10 indicating the content of the news, in response to the browsing of the news by the user, and generates the lyrics data 30. Then, the lyrics generation apparatus 2000 outputs the generated lyrics data 30. As a result, the user can browse the lyrics generated based on the news, together with the news. The timing when the lyrics data 30 is output is not limited to the timing when the user browses the news.

### Second Example Embodiment

### Overview

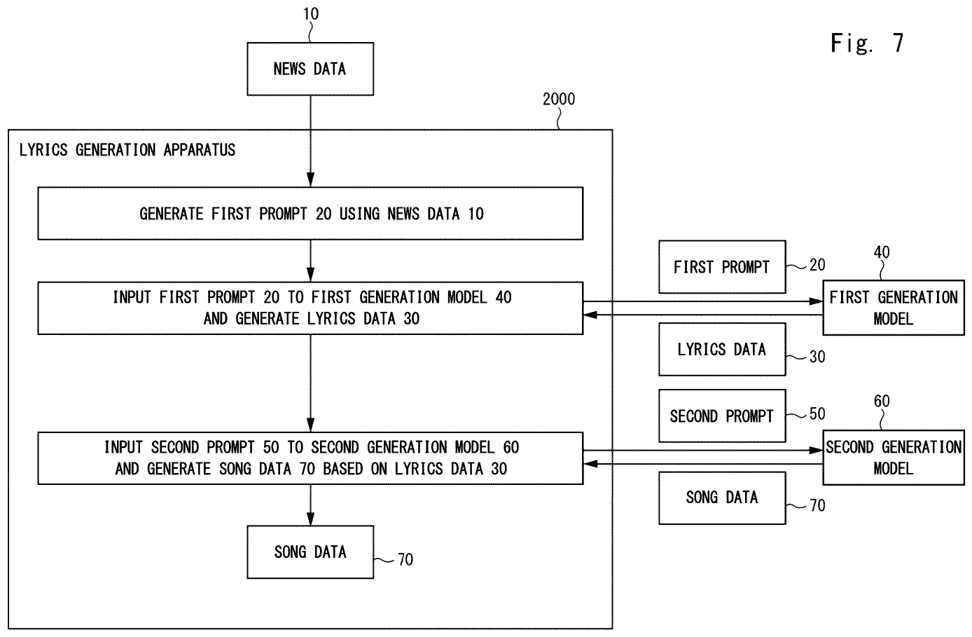

FIG. 7 is a diagram illustrating an overview of an operation of a lyrics generation apparatus 2000. Here, FIG. 7 is a diagram for facilitating understanding of the overview of the lyrics generation apparatus 2000, and the operation of the lyrics generation apparatus 2000 is not limited to that illustrated in FIG. 7.

In a second example embodiment, the lyrics generation apparatus 2000 generates song data 70 using a second generation model 60. The song data 70 is data representing vocal voice of lyrics indicated by lyrics data 30 or data representing voice obtained by combining the vocal voice and accompaniment voice.

The second generation model 60 outputs voice data of a song, in response to an input of a prompt indicating an instruction for generating voice data of the song based on specific lyrics. The voice data of the song output from the second generation model 60 represents, at least, vocal voice of lyrics specified by the prompt. The voice data of the song output from the second generation model 60 may represent voice obtained by combining the vocal voice and the accompaniment voice.

The lyrics generation apparatus 2000 generates the song data 70 based on the lyrics data 30, by inputting a second prompt 50 to the second generation model 60. The second prompt 50 is a prompt that indicates an instruction for generating a song using the lyrics indicated by the lyrics data 30. The song data 70 is output from the second generation model 60, by inputting the second prompt 50 to the second generation model 60.

### Example of Operation and Effect

According to the lyrics generation apparatus 2000, the song data 70 including vocal voice of lyrics is obtained, for the lyrics generated based on a summary of news, a keyword of the news, or both of these. A user can grasp content of the lyrics, by listening to voice reproducing the song data 70, without reading the lyrics indicated by the lyrics data 30 by oneself. Therefore, the user can more easily grasp content of the lyrics data 30.

Hereinafter, the lyrics generation apparatus 2000 according to the present example embodiment will be described in more detail.

### Example of Functional Configuration

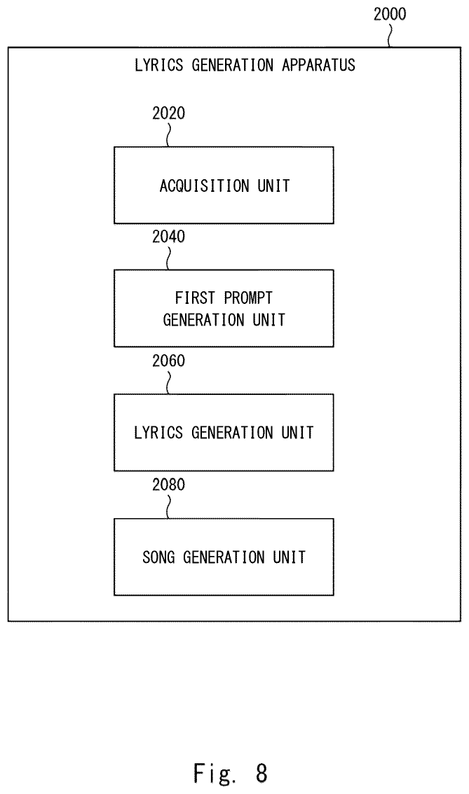

FIG. 8 is a block diagram illustrating a functional configuration of the lyrics generation apparatus 2000. The lyrics generation apparatus 2000 includes a song generation unit 2080, in addition to an acquisition unit 2020, a first prompt generation unit 2040, and a lyrics generation unit 2060. The song generation unit 2080 generates the song data 70 based on the lyrics data 30, by inputting the second prompt 50 to the second generation model 60.

### Example of Hardware Configuration

A hardware configuration of the lyrics generation apparatus 2000 according to the second example embodiment is illustrated, for example, in FIG. 3, similarly to the hardware configuration of the lyrics generation apparatus 2000 according to the first example embodiment. However, a storage device 1080 of the second example embodiment stores a program for achieving a function of the lyrics generation apparatus 2000 according to the second example embodiment.

### Flow of Processing

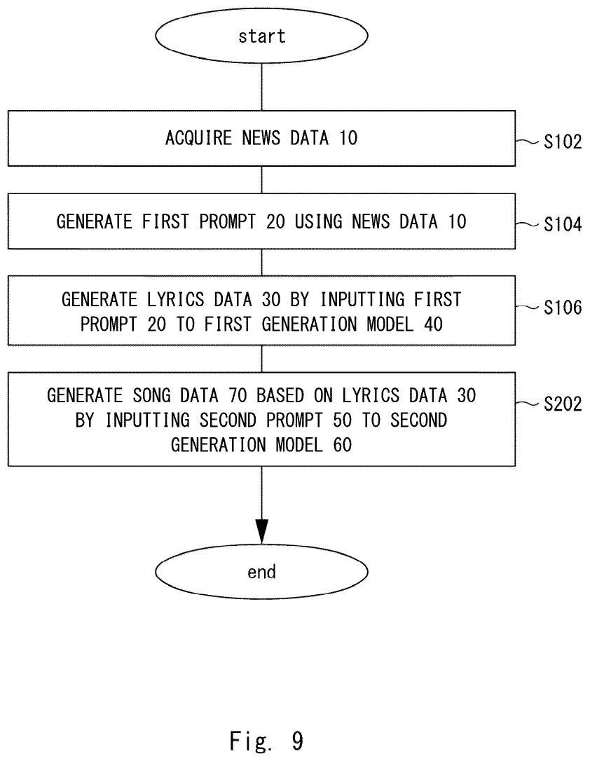

FIG. 9 is a flowchart illustrating a flow of processing executed by the lyrics generation apparatus 2000. S102 to S106 are as described with reference to FIG. 4. After executing S106, the song generation unit 2080 generates the song data 70 based on the lyrics data 30, by inputting the second prompt 50 to the second generation model 60 (S202).

### About Generation of Song Data 70

The song generation unit 2080 generates the song data 70, by inputting the second prompt 50 to the second generation model 60. The second prompt 50 is the prompt that indicates the instruction for generating the song using the lyrics indicated by the lyrics data 30. For example, the second prompt 50 indicates a fixed instruction sentence such as “Please create song using input lyrics”. In this way, in a case where the lyrics data 30 is not included in the second prompt 50, the song generation unit 2080 inputs the lyrics data 30 to the second generation model 60, together with the second prompt 50. The second generation model 60 generates the song data 70 using the lyrics data 30, according to the instruction indicated in the second prompt 50.

The song generation unit 2080 may generate the second prompt 50 in such a way as to include the content of the lyrics data 30. In this case, for example, the second prompt 50 is generated to indicate the lyrics indicated by the lyrics data 30, following an instruction “Please create song using the following lyrics”.

The second prompt 50 may include one or more song parameters. For example, the second prompt 50 includes a song parameter same as the song parameter indicated by the first prompt 20. In this way, in a case where the first prompt 20 and the second prompt 50 include the same song parameter, the same value is set to a value of the song parameter for the first prompt 20 and the second prompt 50.

The second prompt 50 may include a song parameter that is not included in the first prompt 20. For example, while the lyrics generation apparatus 2000 includes a section configuration in the first prompt 20, the lyrics generation apparatus 2000 includes a genre, a tempo, a mood, and a scene in the second prompt 50.

The second prompt 50 is generated using a template similarly to the generation of the first prompt 20, for example. However, a method of generating the second prompt 50 is not limited to the method using the template.

The song generation unit 2080 may specify a value of the song parameter to be included in the second prompt 50, by a method similar to the method of specifying the value of the song parameter included in the first prompt 20. For example, the song generation unit 2080 specifies the value of the song parameter to be included in the second prompt 50, using the schedule information 200 described above.

For example, as described above, it is assumed that, while the section configuration is included in the first prompt 20, the genre, the tempo, the mood, and the scene be included in the second prompt 50. In this case, the first prompt generation unit 2040 refers to the schedule information 200 and specifies the genre, the tempo, the mood, and the scene to be included in the first prompt 20. The song generation unit 2080 refers to the schedule information 200 and specifies the section configuration included in the second prompt 50.

A method of automatically specifying the value of the song parameter is not limited to the method using the schedule information 200. For example, the song generation unit 2080 specifies an entity related to news, using news data 10 and includes a value of a song parameter determined in association with the specified entity, in the second prompt 50 In addition, for example, the song generation unit 2080 includes a value of a song parameter determined in association with a keyword extracted from the news data 10, in the second prompt 50.

Here, the lyrics generation apparatus 2000 may generate the song data 70 for each of the plurality of users, from a common single piece of the lyrics data 30. For example, as in a case where the news data 10 is acquired using a ranking of the news, there is a case where the same news data 10 is used for the plurality of users. In such a case, the lyrics generation apparatus 2000 may generate the song data 70 for each of the plurality of users, using the single piece of the lyrics data 30 generated from the single piece of the news data 10.

For example, it is assumed that the value of the song parameter included in the second prompt 50 be specified using information provided for each user (for example, schedule information 200 provided for each user). In this case, content of the second prompt 50 is different for each user. Therefore, the lyrics generation apparatus 2000 generates the song data 70 for each of the plurality of users, using the second prompt 50 generated for each of the plurality of users, using the common lyrics data 30.

### About Second Generation Model 60

The second generation model 60 may be a general-purpose generation model or may be a generation model exclusively prepared for the lyrics generation apparatus 2000. In the former case, the second generation model 60 is a generation model trained in advance to output a song related to optional lyrics. For example, the second generation model 60 is trained, using a plurality of pieces of training data (hereinafter, third training data) in which a text of optional lyrics and a ground truth song for the text of the lyrics are associated.

In a case where the second generation model 60 is the generation model exclusively prepared for the lyrics generation apparatus 2000, the second generation model 60 is trained, using a plurality of pieces of training data (hereinafter, fourth training data) in which the second prompt 50 and a ground truth song related to the second prompt 50 are associated.

In addition, the second generation model 60 may be a generation model that is further trained using the fourth training data, for a general-purpose generation model generated by training using the third training data.

### Output by Lyrics Generation Apparatus 2000

The lyrics generation apparatus 2000 may output a processing result by any method. For example, the lyrics generation apparatus 2000 outputs the song data 70. An output mode of the song data 70 is, for example, similar to an output mode of the lyrics data 30. In addition, for example, the lyrics generation apparatus 2000 may output the song indicated by the song data 70 by voice, by reproducing the song data 70 and outputting the song data 70 to any speaker. The lyrics generation apparatus 2000 may cause the speaker to output the voice of the song data 70 and cause the display device to display the content of the lyrics data 30.

The song data 70 is output, for example, at a timing when the user browses the news. In this case, the lyrics generation apparatus 2000 acquires the news data 10 indicating the content of the news, in response to the browsing of the news by the user, and generates the lyrics data 30. Moreover, the lyrics generation apparatus 2000 generates the song data 70, using the lyrics data 30. Then, the lyrics generation apparatus 2000 outputs the generated song data 70. As a result, the user can listen to the song generated based on the news while browsing the news. The timing when the song data 70 is output is not limited to the timing when the user browses the news.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each embodiment can be appropriately combined with other embodiments.

Each of the drawings is merely an example for describing one or more example embodiments. Each of the drawings is not associated with only one specific example embodiment, but may be associated with one or more other example embodiments. As those of ordinary skill in the art will appreciate, various features or steps described with reference to any one of the drawings may be combined with features or steps illustrated in one or more other drawings, for example, to create an example embodiment that is not explicitly illustrated nor described. All of the features or steps illustrated in any one of the drawings for describing illustrative example embodiments are not necessarily mandatory, and some features or steps may be omitted. The order of the steps described in any one of the drawings may be changed as appropriate.

Some or all of the above example embodiments can also be described as the following Supplementary Notes, but are not limited to the following. Some or all of the elements described in the optional Supplementary Note can be applied to various types of hardware and software and recording means, systems, and methods of recording various types of software.

Some or all of the example embodiments described above may also be described as, but are not limited to, the following supplementary notes.
(Supplementary Note 1)
A lyrics generation apparatus including:
   acquisition means for acquiring news data indicating content of news;
   first prompt generation means for generating, by using the news data, a first prompt that instructs to generate lyrics of a song based on a summary of the news, a keyword of the news, or both thereof; and
   lyrics generation means for generating lyrics data indicating the lyrics, by inputting the first prompt to a first generation model.
(Supplementary Note 2)
The lyrics generation apparatus according to supplementary note 1,
   wherein the first prompt generation means generates the first prompt indicating a value of each of one or more parameters related to the song, and
   wherein the parameter is a genre, a tempo, a mood, a scene, or a section configuration.
(Supplementary Note 3)
The lyrics generation apparatus according to supplementary note 2, wherein the first prompt generation means generates the first prompt indicating the values of the one or more parameters, by using schedule information indicating the values of the one or more parameters in association with each of a plurality of conditions of a schedule.
(Supplementary Note 4)
The lyrics generation apparatus according to supplementary note 1, in which the first prompt generation means generates the first prompt indicating a word or a phrase that should not be included in the lyrics or indicating a type of the word or the phrase that should not be included in the lyrics.
(supplementary Note 5)
The lyrics generation apparatus according to supplementary note 1, wherein the first prompt generation means generates the first prompt indicating a creation intention of the lyrics.
(Supplementary Note 6)
The lyrics generation apparatus according to supplementary note 1, further including song generation means for generating song data indicating the song, by inputting a second prompt that instructs to generate the song based on the lyrics data to a second generation model.
(Supplementary Note 7)
The lyrics generation apparatus according to supplementary note 6,
   wherein the song generation means generates the second prompt that indicates a value of each of one or more parameters related to the song, and
   wherein the parameter is a genre, a tempo, a mood, a scene, or a section configuration.
(Supplementary Note 8)
The lyrics generation apparatus according to supplementary note 7, wherein the song generation means generates the second prompt indicating values of the one or more parameters, by using schedule information indicating the values of the one or more parameters in association with each of a plurality of conditions of a schedule.
(Supplementary Note 9)
A lyrics generation method executed by a computer, including:
   an acquisition step for acquiring news data indicating content of news;
   a first prompt generation step for generating, by using the news data, a first prompt that instructs to generate lyrics of a song based on a summary of the news, a keyword of the news, or both thereof; and
   a lyrics generation step for generating lyrics data indicating the lyrics, by inputting the first prompt to a first generation model.
(Supplementary Note 10)
The lyrics generation method according to supplementary note 9,
   wherein the generation of the first prompt includes generating the first prompt indicating a value of each of one or more parameters related to the song, and
   wherein the parameter is a genre, a tempo, a mood, a scene, or a section configuration.
(Supplementary Note 11)
The lyrics generation method according to supplementary note 10, wherein the generation of the first prompt includes generating the first prompt indicating the values of the one or more parameters, by using schedule information indicating the values of the one or more parameters in association with each of a plurality of conditions of a schedule.
(Supplementary Note 12)
The lyrics generation method according to supplementary note 9, wherein the generation of the first prompt includes generating the first prompt indicating a word or a phrase that should not be included in the lyrics or indicating a type of the word or the phrase that should not be included in the lyrics.
(Supplementary Note 13)
The lyrics generation method according to supplementary note 9, wherein the generation of the first prompt includes generating the first prompt indicating a creation intention of the lyrics.
(Supplementary Note 14)
The lyrics generation method according to supplementary note 9, further comprising generating song data indicating the song, by inputting a second prompt that instructs to generate the song based on the lyrics data to a second generation model.
(Supplementary Note 15)
A non-transitory computer-readable medium storing a program that causes a computer to execute:
   acquiring news data indicating content of news;
   generating, by using the news data, a first prompt that instructs to generate lyrics of a song based on a summary of the news, a keyword of the news, or both thereof; and
   generating lyrics data indicating the lyrics, by inputting the first prompt to a first generation model.
(Supplementary Note 16)
The medium according to supplementary note 15,
   wherein the generation of the first prompt includes generating the first prompt indicating a value of each of one or more parameters related to the song, and
   wherein the parameter is a genre, a tempo, a mood, a scene, or a section configuration.
(Supplementary Note 17)
The medium according to supplementary note 16, wherein the generation of the first prompt includes generating the first prompt indicating the values of the one or more parameters, by using schedule information indicating the values of the one or more parameters in association with each of a plurality of conditions of a schedule.
(Supplementary Note 18)
The medium according to supplementary note 15, wherein the generation of the first prompt includes generating the first prompt indicating a word or a phrase that should not be included in the lyrics or indicating a type of the word or the phrase that should not be included in the lyrics.
(Supplementary Note 19)
The medium according to supplementary note 15, wherein the generation of the first prompt includes generating the first prompt indicating a creation intention of the lyrics.
(Supplementary Note 20)
The medium according to supplementary note 15, wherein the program causes the computer to further execute generating song data indicating the song, by inputting a second prompt that instructs to generate the song based on the lyrics data to a second generation model.

What is claimed is:

1. A lyrics generation apparatus comprising:
at least one memory that is configured to store instructions; and
at least one processor that is configured to execute the instructions to:
acquire news data indicating content of news;
generate, by using the news data, a first prompt that instructs to generate lyrics of a song based on a summary of the news, a keyword of the news, or both thereof; and
generate lyrics data indicating the lyrics, by inputting the first prompt to a first generation model.

2. The lyrics generation apparatus according to claim 1,
wherein the generation of the first prompt includes generating the first prompt indicating a value of each of one or more parameters related to the song, and
wherein the parameter is a genre, a tempo, a mood, a scene, or a section configuration.

3. The lyrics generation apparatus according to claim 2, wherein the generation of the first prompt includes generating the first prompt indicating the values of the one or more parameters, by using schedule information indicating the values of the one or more parameters in association with each of a plurality of conditions of a schedule.

4. The lyrics generation apparatus according to claim 1, wherein the generation of the first prompt includes generating the first prompt indicating a word or a phrase that should not be included in the lyrics or indicating a type of the word or the phrase that should not be included in the lyrics.

5. The lyrics generation apparatus according to claim 1, wherein the generation of the first prompt includes generating the first prompt indicating a creation intention of the lyrics.

6. The lyrics generation apparatus according to claim 1, wherein the at least one processor is configured further to generate song data indicating the song, by inputting a second prompt that instructs to generate the song based on the lyrics data to a second generation model.

7. The lyrics generation apparatus according to claim 6,
wherein the generation of the song data includes generating the second prompt that indicates a value of each of one or more parameters related to the song, and
wherein the parameter is a genre, a tempo, a mood, a scene, or a section configuration.

8. The lyrics generation apparatus according to claim 7, wherein the generation of the song data includes generating the second prompt indicating values of the one or more parameters, by using schedule information indicating the values of the one or more parameters in association with each of a plurality of conditions of a schedule.

9. A lyrics generation method executed by a computer, comprising:
acquiring news data indicating content of news;
generating, by using the news data, a first prompt that instructs to generate lyrics of a song based on a summary of the news, a keyword of the news, or both thereof; and
generating lyrics data indicating the lyrics, by inputting the first prompt to a first generation model.

10. The lyrics generation method according to claim 9,
wherein the generation of the first prompt includes generating the first prompt indicating a value of each of one or more parameters related to the song, and
wherein the parameter is a genre, a tempo, a mood, a scene, or a section configuration.

11. The lyrics generation method according to claim 10, wherein the generation of the first prompt includes generating the first prompt indicating the values of the one or more parameters, by using schedule information indicating the values of the one or more parameters in association with each of a plurality of conditions of a schedule.

12. The lyrics generation method according to claim 9, wherein the generation of the first prompt includes generating the first prompt indicating a word or a phrase that should not be included in the lyrics or indicating a type of the word or the phrase that should not be included in the lyrics.

13. The lyrics generation method according to claim 9, wherein the generation of the first prompt includes generating the first prompt indicating a creation intention of the lyrics.

14. The lyrics generation method according to claim 9, further comprising generating song data indicating the song, by inputting a second prompt that instructs to generate the song based on the lyrics data to a second generation model.

15. A non-transitory computer-readable medium storing a program that causes a computer to execute:
acquiring news data indicating content of news;
generating, by using the news data, a first prompt that instructs to generate lyrics of a song based on a summary of the news, a keyword of the news, or both thereof; and
generating lyrics data indicating the lyrics, by inputting the first prompt to a first generation model.

16. The medium according to claim 15,
wherein the generation of the first prompt includes generating the first prompt indicating a value of each of one or more parameters related to the song, and
wherein the parameter is a genre, a tempo, a mood, a scene, or a section configuration.

17. The medium according to claim 16, wherein the generation of the first prompt includes generating the first prompt indicating the values of the one or more parameters, by using schedule information indicating the values of the one or more parameters in association with each of a plurality of conditions of a schedule.

18. The medium according to claim 15, wherein the generation of the first prompt includes generating the first prompt indicating a word or a phrase that should not be included in the lyrics or indicating a type of the word or the phrase that should not be included in the lyrics.
